(19) United States
(12) Patent Application Publication
(10) Pub. No.: US 2015/0347996 A1
(43) Pub. Date: Dec. 3, 2015

(54) SHARED PURCHASES

(71) Applicant: Apple Inc., Cupertino, CA (US)

(72) Inventors: Thomas Alsina, Mountain View, CA (US); Augustin J. Farrugia, Los Altos Hills, CA (US); Edward T. Schmidt, Burlingame, CA (US); Gianpaolo Fasoli, Palo Alto, CA (US); Sean B. Kelly, San Francisco, CA (US)

(21) Appl. No.: 14/722,019

(22) Filed: May 26, 2015

Related U.S. Application Data
(60) Provisional application No. 62/005,902, filed on May 30, 2014.
(60) Provisional application No. 62/020,828, filed on Jul. 3, 2014.

(51) Int. Cl. G06Q 20/12; G06F 21/10; G06Q 20/40; G06Q 20/22; H04L 29/08; H04L 29/06

(52) U.S. Cl. CPC G06Q 20/1235; H04L 67/306; H04L 67/42; G06Q 20/405; G06Q 20/29; G06F 21/10

(57) ABSTRACT

One or more user accounts can be linked together to form a group of linked user accounts to access content items assigned to the other user accounts in the group of linked user accounts. Prior to completing a purchase for a content item, a requesting user can be alerted that a member of the group of linked user accounts has access to the content item. Content items assigned to a member of a group of linked user accounts can be downloaded by one or more other members of the group of linked user accounts along with a Digital Rights Management (DRM) key that enables use of the content item. The DRM key can represent the group relationship between the downloading user account and the content owner's user account to which the content item is assigned.

### RELATED APPLICATIONS

This application claims the benefit of U.S. Provisional Application No. 62/005,902, entitled “SHARED PURCHASES”, filed on May 30, 2014, and U.S. Provisional Application No. 62/020,828, entitled “SHARED PURCHASES”, filed on Jul. 3, 2014, both of which are hereby expressly incorporated by reference in their entirety.

### TECHNICAL FIELD

The present technology pertains to sharing content items, and more specifically pertains to sharing purchased content items amongst members of a group of linked user accounts.

### BACKGROUND

Online stores allow users to purchase a variety of content items from the comfort of their computing device. For example, online media stores allow users to purchase a variety of electronic content items such as music, movies, books, etc., which a user can access from their computing device(s). While users can easily purchase these items online, sharing these items with family members can be difficult. Oftentimes, access to purchased content items is restricted to the user account that purchased the content item. Therefore, a user that purchased content item cannot share the content item with other members of their family.

To alleviate this problem, many families share a single user account to make content item purchases. While sharing a single user account allows multiple family members to access purchased content items, this technique also provides several problems. For example, by sharing a single user account, purchases made by each family member affect the user profile associated with the purchasing user account. Therefore, a father that allows his children to purchase songs using the father's user account may receive recommendations based on the purchases made by the children because the system cannot discern between purchases made by the father and purchases made by his children.

Another problem with sharing a single user account is that the purchased content items are associated with the user account used to purchase the content items and cannot be transferred to another user account. This can be problematic when a family member wants to create a separate user account. For example, a child leaving for college may wish to have their own user account, separate from the user account shared with the child's father. The child has no way to transfer the child's content items purchased with the father's user account. Accordingly, there is a need for an improved method of sharing purchased content items between family members.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for sharing content items amongst members of a group of linked user accounts. One or more user accounts can be linked together to form a group of linked user accounts. When linked, the user accounts in the group of linked user accounts can access content items assigned to the other user accounts in the group of linked user accounts. This can allow family members to link their user accounts into a group of linked user accounts to share their purchases, photos, etc., with the other members of their family.

In some embodiments, a user can be alerted that a member of the group of linked user accounts has access to a content item. For example, prior to completing a purchase request for a content item available on an online store, the content items assigned to the user accounts in the group of linked user accounts can be searched to determine whether a member of the group of user accounts has access to the requested content item. If so, the requesting user can be alerted that another member of the group of linked user accounts has access to the requested content item and the requesting user can thus access the requested content item without purchase. This can include streaming the content item and/or downloading the content item to a client device.

In some embodiments, content items assigned to a member of a group of linked user accounts can be downloaded by one or more other members of the group of linked user accounts. This can allow the members of the group of linked user accounts to access content items assigned to the other members of the group of linked user accounts from their client device while their client device is offline. To enable access to the downloaded content item, a Digital Rights Management (DRM) key that enables use of the content item can be transmitted to the client device along with the content item. The DRM key can enable the client device to decrypt and operate the content item.

In some embodiments, the DRM key provided along with a shared content item can represent the group relationship between the downloading user account and the content owner's user account. If either user account (downloading user account or content owner's user account) leaves the group of linked user accounts or the relationship between the two accounts is severed in any other way, the DRM key representing the group relationship between the two user accounts can be invalidated, thereby restricting the downloading user account from accessing the downloaded content item on the downloading user's client device.

In some embodiments, whether a downloaded content item is a shared content item can be determined when the content item is downloaded to a client device. Each content item can be tagged with a content owner identifier that identifies the user account to which the content item is assigned. The content owner identifier tagged to a downloaded content item can be compared to a downloading account identifier that identifies the user account authorized on the client device that downloaded the content item. If the content owner identifier and downloading account identifier match, the downloaded content item belongs to the downloading user account, and thus is not a shared content item. Alternatively, if the content owner identifier and downloading account identifier do not match, the content item does not belong to the downloading user account and the content item is therefore a shared content item belonging to a different user account in the group of linked user accounts.

Content items determined to be shared content items can be tagged or flagged as shared content items. If the downloading user account then leaves a group of linked user accounts, the content items flagged as shared content items can then be disabled and/or removed from the downloading user's client devices.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network in accordance with the invention;

FIGS. 2A, 2B, and 2C illustrate an exemplary embodiment of linking multiple user accounts together;

FIG. 3 illustrates an exemplary method embodiment of notifying a member of a group of linked user account that a content item can be accessed as a shared content item;

FIGS. 4A-4C illustrate exemplary screen shots of a content item interface;

FIG. 5 illustrates an exemplary method embodiment of providing a DRM key along with a content item;

FIG. 6 illustrates an exemplary method embodiment of invalidating DRM keys;

FIG. 7 illustrates an exemplary method embodiment of determining if a downloaded content item is a shared content item; and

FIGS. 8A and 8B show exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for sharing content items amongst members of a group of linked user accounts. One or more user accounts can be linked together to form a group of linked user accounts. When linked, the user accounts in the group of linked user accounts can access content items assigned to the other user accounts in the group of linked user accounts. This can allow family members to link their user accounts into a group of linked user accounts to share their purchases, photos, etc., with the other members of their family.

In some embodiments, a user can be alerted that a member of the group of linked user accounts has access to a content item. For example, prior to completing a purchase request for a content item available on an online store, the content items assigned to the user accounts in the group of linked user accounts can searched to determine whether a member of the group of user accounts has access to the requested content item. If so, the requesting user can be alerted that another member of the group of linked user accounts has access to the requested content item and the requesting user can thus access the requested content item without purchase. This can include streaming the content item and/or downloading the content item to a client device.

In some embodiments, content items assigned to a member of a group of linked user accounts can be downloaded by one or more other members of the group of linked user accounts. This can allow the members of the group of linked user accounts to access content items assigned to the other members of the group of linked user accounts from their client device while their client device is offline. To enable access to the downloaded content item, a Digital Rights Management (DRM) key that enables use of the content item can be transmitted to the client device along with the content item. The DRM key can enable the client device to decrypt and operate the content item.

In some embodiments, the DRM key provided along with a shared content item can represent the group relationship between the downloading user account and the content owner's user account. If either user account (downloading user account or content owner's user account) leaves the group of linked user accounts or the relationship between the two accounts is severed in any other way, the DRM key representing the group relationship between the two user accounts can be invalidated, thereby restricting the downloading user account from accessing the downloaded content item on the downloading user's client device.

In some embodiments, whether a downloaded content item is a shared content item can be determined when the content item is downloaded to a client device. Each content item can be tagged with a content owner identifier that identifies the user account to which the content item is assigned. The content owner identifier tagged to a downloaded content item can be compared to a downloading account identifier that identifies the user account authorized on the client device that downloaded the content item. If the content owner identifier and downloading account identifier match, the downloaded content item belongs to the downloading user account, and thus is not a shared content item. Alternatively, if the content owner identifier and downloading account identifier do not match, the content item does not belong to the downloading user account and the content item is therefore a shared content item belonging to a different user account in the group of linked user accounts.

Content items determined to be shared content items can be tagged or flagged as shared content items. If the downloading user account then leaves a group of linked user accounts, the content items flagged as shared content items can then be disabled and/or removed from the downloading user's client devices.

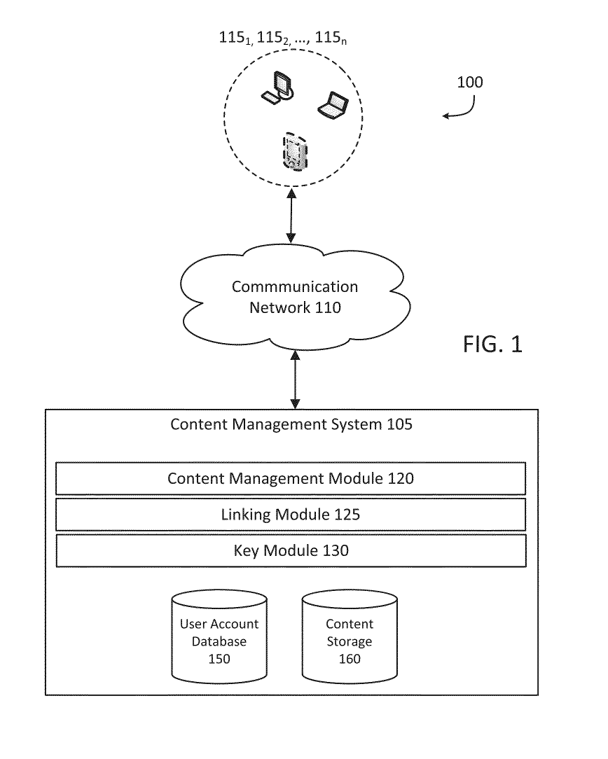

FIG. 1 illustrates an exemplary system configuration 100, wherein electronic devices communicate via a network for purposes of exchanging content and other data. As illustrated, multiple computing devices (client devices 115 and content management system 105) can be connected to communication network 110 and be configured to communicate with each other through use of communication network 110. Communication network 110 can be any type of network, including a local area network (“LAN”), such as an intranet, a wide area network (“WAN”), such as the internet, or any combination thereof. Further, communication network 110 can be a public network, a private network, or a combination thereof. Communication network 110 can also be implemented using any number of communications links associated with one or more service providers, including one or more wired communication links, one or more wireless communication links, or any combination thereof. Additionally, communication network 110 can be configured to support the transmission of data formatted using any number of protocols.

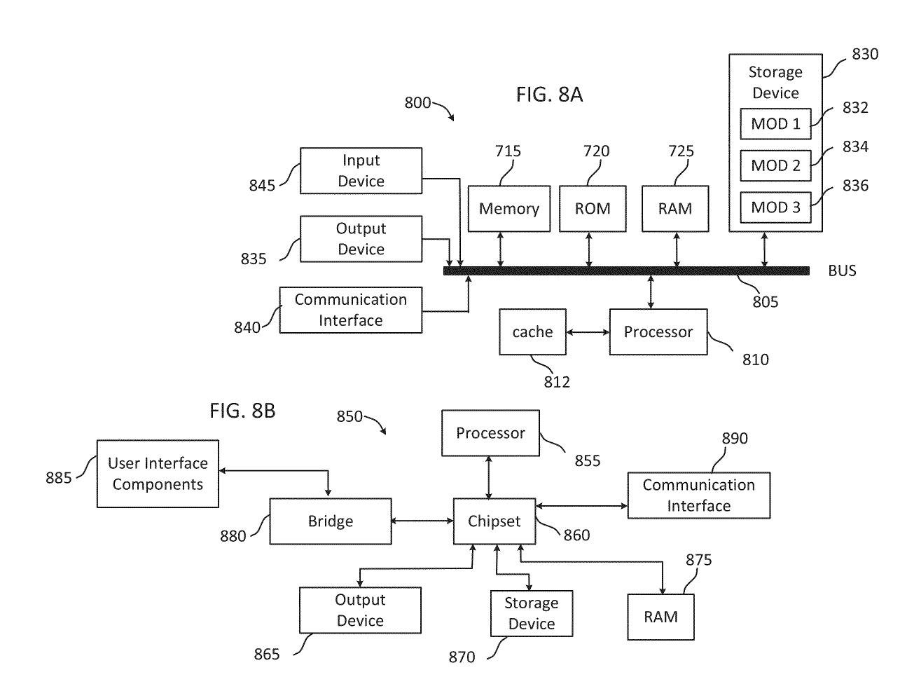

Multiple computing devices can be connected to communication network 110. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 800 of FIGS. 8A and 8B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

In system 100, a user can interact with content management system 105 through client devices 115₁, 115₂, . . . , 115ₙ (collectively “115”) connected to communication network 110 by direct and/or indirect communication. Content management system 105 can support connections from a variety of different client devices 115, such as desktop computers; mobile computers; mobile communications devices, e.g. mobile phones, smart phones, tablets; smart televisions; set-top boxes; and/or any other network enabled computing devices. Client devices 115 can be of varying type, capabilities, operating systems, etc. Furthermore, content management system 105 can concurrently accept connections from and interact with multiple client devices 115.

A user can interact with content management system 105 via a client-side application installed on client device 115ᵢ. In some embodiments, the client-side application can include a content management system specific component. For example, the component can be a stand-alone application, one or more application plug-ins, and/or a browser extension. However, the user can also interact with content management system 105 via a third-party application, such as a web browser, that resides on client device 115ᵢ and is configured to communicate with content management system 105. In either case, the client-side application can present a user interface (UI) for the user to interact with content management system 105. For example, the user can interact with the content management system 105 via a client-side application integrated with the file system or via a webpage displayed using a web browser application.

Content management system 105 can be configured to manage content items for multiple user accounts. For example, content management system 105 can allow users to purchase, store and access content items. Furthermore, content management system 105 can make it possible for a user to access the content items from multiple client devices 115. Accessing a content item can include receiving metadata describing the content item, streaming the content item from content management system 105, downloading the content item or purchasing the content item.

To facilitate the various content management services, a user can create a user account with content management system 105. The account information for each created user account can be maintained in user account database 150. User account database 150 can store profile information for each user account, including a unique account identifier identifying the user account, personal information, username, password, email address, address, credit card information, banking information, client devices belonging to the user, etc. User account database 150 can also include account management information, such as content storage locations, security settings, personal configuration settings, client devices authorized to access the user account, etc.

A user account can be used to purchase, manage and store content items, such as digital data, documents, text files, audio files, video files, image files, applications, etc. In some embodiments, a content item can be an item that is subject to a licensing restriction. For example, content management system 105 can provide an online content store where users can purchase a variety of content items. Further, in some embodiments, a user can upload content items from one of client devices 115 to content management system 105. The purchased and uploaded content items can be assigned to the user's user account and then accessed by the user from any of client devices 115 when logged into the user's user account. For example, a content item identifier identifying each content item assigned to a user account can be stored in user account database 150 and associated with the corresponding user account. The content item identifier can be used to identify the content item as well as the location of the content item.

The content items can be stored in content storage 160. Content storage 160 can be a storage device, multiple storage devices, or a server. Alternatively, content storage 160 can be a cloud storage provider or network storage accessible via one or more communications networks. Content management system 105 can hide the complexity and details from client devices 115 so that client devices 115 do not need require information detailing the exact location at which the content items are being stored by content management system 105. Content management system 105 can store the content items in a network accessible storage (NAS) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various user accounts. The metadata for a content item can be stored as part of the content item or can be stored separately. In one variation, each content item stored in content storage 160 can be assigned a system-wide unique identifier.

Content management system 105 can include content management module 120 configured to manage and access each user account and the content items assigned to the user accounts. For example, content management module 120 can be configured to communicate with user account database 150 and content storage 160 to adjust privileges with respect to content items and otherwise manage content items.

A user can communicate with content management system 105 via client device 115, to request to login into their user account. Content management system 105 can require that a user provide login credentials, such as a user name and password, touch identification, etc., to login into their user account. Upon receiving the correct login credentials for a user account, content management system 105 can authorize the requesting user's client device 115ᵢ on the user account, thereby allowing client device 115ᵢ to access content items assigned to the user account, make purchases with the payment method associated with the user account, assign content items to the user account, upload content items, etc.

In some embodiments, content management system 105 can limit the number of user accounts on which a client device 115 can be authorized at a time. For example, content management system 105 can limit a client device to being authorized on no more than one user account at a time. This can require a client device 115ᵢ to log out of a user account prior to logging into a different user account, thereby authorizing the client device on the different user account.

While content management system 105 can be configured to limit client devices 115 to being authorized on only one user account at a time, content management system 105 can allow for multiple client devices 115 to be authorized on the same user account simultaneously. This can allow a user to access their user account from multiple devices, such as their tablet PC, desktop PC and smartphone.

Upon a user logging into their user account from client device 115ᵢ, thereby authorizing client device 115ᵢ on their user account, content management module 120 can access the account information associated with the user account to identify the content items assigned to the user account, as well as account configuration data dictating presentation of the content items. Content management module 120 can then present and/or provide the content items to client device 115ᵢ according to the account configuration data. For example, content management module 120 can access a user account to identify the content item identifiers assigned to the user account. The content item identifier can then be used to identify and locate the content items assigned to the user account, which can be transmitted to client device 115ᵢ, where they can be presented according to the account configuration data.

Presenting the content items can include transmitting metadata describing the content items to client device 105ᵢ that is authorized on the user account. Client device 105ᵢ can then use the received metadata to present the content items that the user account can access. For example, client device 105ᵢ can present information identifying the content items in a content item library available to the user account. This can include presenting the title of the content item, an image such as an album or book cover, description, etc.

Content management module 120 can also assign content items to a user account. For example, upon a user purchasing or uploading a content item, content management module 120 can add a content item identifier identifying the purchased content item to the user account in account database 150, thus enabling the user account to access the content item.

In some embodiments, content management system 105 can be configured to link multiple user accounts together to form a group of linked user accounts so that content items assigned to each of the individual user accounts can be accessed by each of the user accounts in the group linked user account. This can allow family members to link their user accounts together to share their content items with each other, while maintaining their personal user account.

To link user accounts together, content management system 105 can include linking module 125. In some embodiments, linking module 125 can be configured to provide an account link interface that enables a user to link their user account to other user accounts. For example, the account link interface can enable a user to request that their user account be linked to another user account and/or accept a request received from another user account. Upon logging into their user account, a user can use the account link interface to link their user account to the user account of other users.

To link multiple user accounts together, linking module 125 can be configured to modify the account information of the linked user accounts to indicate that the user accounts are linked together. For example, in some embodiments, linking module 125 can modify a user account to include the unique account identifier of each user account linked to the user account. Account management module 120 can then access a user account to identify each of the user accounts linked to the user account. Likewise, to unlink a user account, linking module 125 can modify the user account of each linked user account to remove the unique account identifier of the user accounts that are no longer linked.

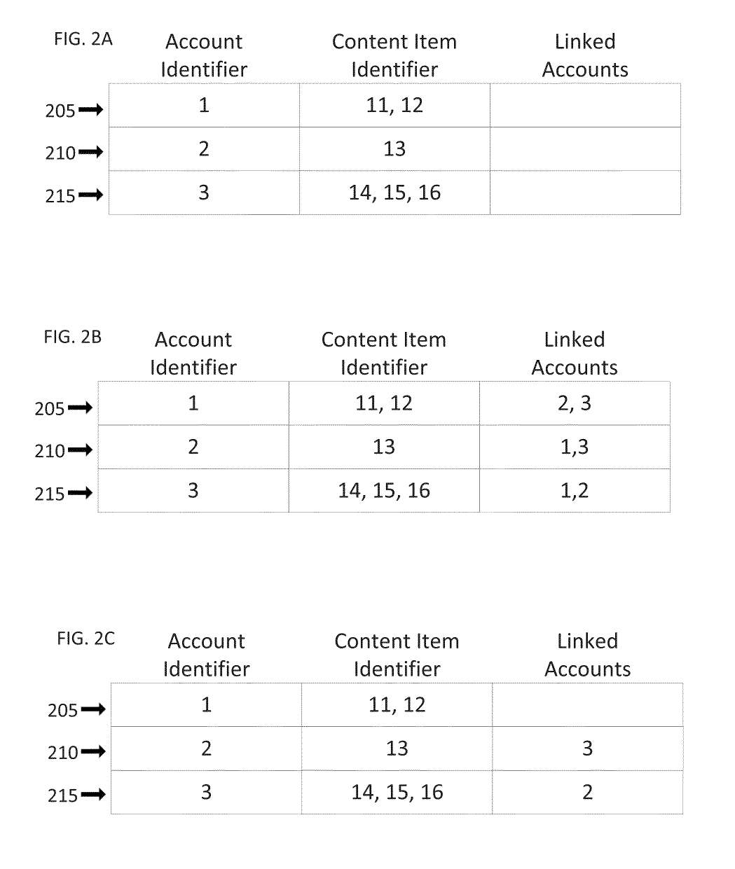

FIGS. 2A-2C illustrate an exemplary embodiment of linking multiple user accounts together. FIG. 2A, illustrates three user accounts: user account 205, user account 210 and user account 215. As shown, each user account (205, 210, 215) includes a unique account identifier field, a content item identifier field and a linked account field.

The unique account identifier field can include a unique account identifier that uniquely identifies a user account. As shown, the unique account identifier for user account 205 is 1; the unique account identifier for user account 210 is 2; and the unique account identifier for user account 215 is 3.

The content item identifier field can include content item identifiers identifying each content item assigned to the individual user account. As shown, content items 11 and 12 are assigned to user account 205, content item 13 is assigned to user account 210, and content items 14, 15 and 16 are assigned to user account 215.

The linked account field can identify the user accounts linked to a user account. For example, the linked account field can include the unique account identifier of each user account linked to the user account. As shown, none of the three user accounts (205, 210, 215) has a unique identifier in their respective linked account field, indicating that none of the user accounts (205, 210, 215) are linked to another user account. Each of the user accounts (205, 210, 215) can therefore access only the content items assigned to their respective user account. Thus user account 205 can access only content items 11 and 12, user account 210 can access only content item 13, and user account 215 can access only content items 14, 15 and 16.

FIG. 2B illustrates user accounts 205, 210 and 215 after they have been linked together to form a group of linked user accounts. As shown, user account 205 includes unique account identifiers 2 and 3 in the linked account field. This indicates that user account 205 is now linked to user accounts 210 and 215. Likewise, user account 210 includes the unique account identifiers 1 and 3 in its linked account field indicating that user account 210 is linked to user accounts 205 and 215, and user account 215 includes unique account identifiers 1 and 2 in its linked account field, indicating that user account 215 is linked to user accounts 205 and 210.

As a result of the user accounts 205, 210 and 215 being linked together, each of the user accounts (205, 210, 215) can access the content items assigned to the other user accounts, in addition to the content items assigned to the individual user account. For example, user account 205 can access content item 13 assigned to user account 210, and content items 14, 15 and 16 assigned to user account 215, in addition to the content items 11 and 12 assigned to user account 205. Likewise, user account 210 can access content items 11, 12, 14 15 and 16 in addition to the content items assigned to user account 210, and user account 215 can access content items 11, 12 and 13, in addition to the content items assigned to user account 215.

FIG. 2C illustrates user accounts 205, 210 and 215 after user account 205 has been removed from the group of linked user accounts. As shown, user account 215 no longer has any unique account identifiers listed in the linked account fields. This can indicate that user account 205 is no longer linked to any other user account. Further, the linked account fields of user accounts 210 and 215 have also been modified to remove the unique account identifier of user account 205, indicating that user accounts 210 and 215 are no longer linked to user account 205.

While user account 205 has been unlinked from user accounts 210 and 215, user accounts 210 and 215 remain linked to each other, as indicated by the linked account field of user accounts 210 and 215. As a result, user account 205 can access only the content items assigned to user account 205, and can no longer access the content items assigned to user accounts 210 and 215. Likewise, user accounts 210 and 215 can no longer access the content items assigned to user account 205, however user accounts 210 and 215 can still access the content items assigned to the other account. Thus, user account 205 can only access content items 11 and 12, whereas user accounts 210 and 215 can each access content items 13, 14, 15 and 16, but not content items 11 and 12.

Although listing unique account identifiers in a user account is used as one example of how user accounts can be linked together, this is only one possible embodiment and is not meant to be limiting. Linking multiple user account together can be performed in any of numerous ways known in the art.

In some embodiments, a group of linked user accounts can be assigned a unique group identifier that identifies the group of linked user accounts. Each user account can include a listing of unique group identifiers that identify each group of linked user accounts to which the user account is a member. Further, a group index can be used to identify the user accounts included in each group of linked user accounts. For example, a group index can list each unique group identifier along with the unique account identifier for each user account included in the group. To identify the user accounts linked to a user account, the user account can be accessed to gather the group identifiers associated with the user account. The group identifiers can then be used to search the group index to identify the user accounts included in each group.

Returning to the discussion of FIG. 1, in some embodiments, content management system 105 can be configured to identify shared content items that each user account in a group of linked user account can access. For example, a user account in a group of linked user accounts can access the shared content items assigned to each user account in the group of linked user account. Content management system 105 can identify the shared content items and then notify or alert each user account in the group of linked user accounts regarding the identified shared content items that can be accessed by the respective user account.

In some embodiments, content management system 105 can be configured to alert or notify a user that a content item is available to the user when the user attempts to purchase the content item. For example, a user may attempt to purchase a content item from an online store provided by content management system 105. Prior to completing the purchase, content management system 105 can determine whether the content item that the user wishes to purchase can be accessed by the user as a shared content item. For example, another member of the group of linked user accounts may have already purchased the content item. If the content item is available to the user as a shared content item, content management system 105 can alert the requesting user that the content item is available to the requesting user without purchase as a shared content item. For example, a user can request to purchase a song that has been already been purchased by another member of the group of linked user account. Prior to completing the requested purchase, content management system 105 can determine whether another member of the group of linked user accounts has already purchased the song and then alert the requesting user that the requested song is available to the requesting user without purchase as a shared content item. The requesting user can then choose to cancel the purchase request.

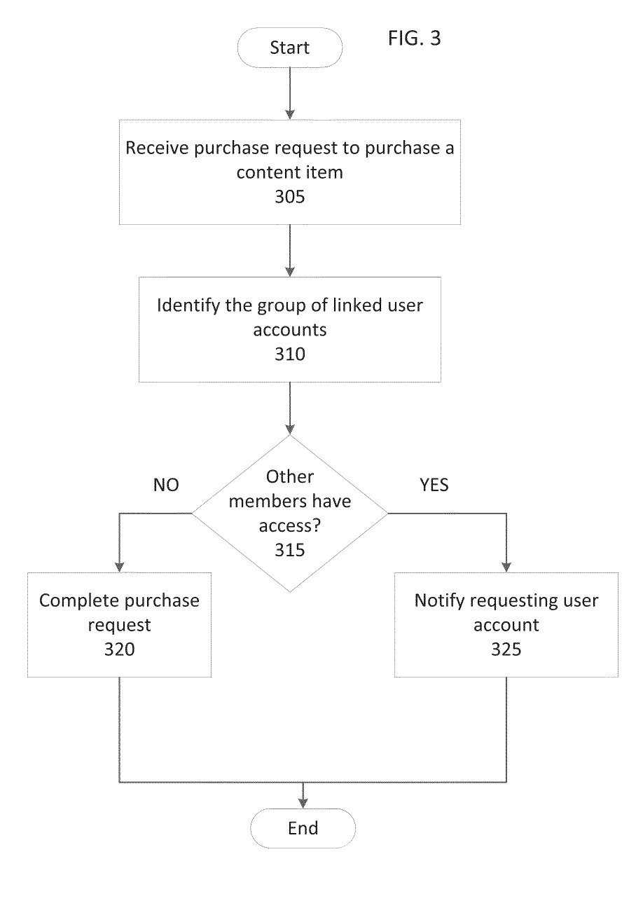

FIG. 3 illustrates an exemplary method embodiment of notifying a member of a group of linked user account that a content item can be accessed as a shared content item. FIG. 3 will be described in view of the system described in FIG. 1.

As shown, the method begins at block 305 where content management system 105 receives a purchase request to purchase a content item. A purchase request can be received from a client device 115ᵢ authorized on a user account of content management system 105. For example, a user can use their client device 115ᵢ to access an online store provided by content management system 105 and request to purchase a content item available on the online store, resulting in the client device 115ᵢ transmitting the content request to content management system 105. The purchase request can identify the requesting user account, i.e. the user account authorized on client device 115ᵢ and the requested content item to be purchased.

At block 310, content management system 105 can identify the group of linked user accounts to which the requesting user account belongs. For example, content management system 105 can search user account database 150 to identify the group of linked user accounts to which the requesting user account is a member.

At block 315, content management system 105 can determine whether any members in the identified group of linked user accounts has access to the requested content item, i.e. the content item requested to be purchased. Content management system 105 can search the user account data in user account database 150 to determine whether any of the members of the group of linked user accounts has access to the requested content item.

If at block 315 content management system 105 determines that none of the members of the group of linked user accounts has access to the requested content item, the method continues to block 320 where content management system 105 completes the purchase request. As a result, content management system 105 can assign the requested content item to the requesting user account, thereby providing the requesting user account with access to the requested content item.

Alternatively, if at block 315, content management system 105 determines that a member of the group of linked user accounts does have access to the requested content item, the method continues to block 325 where content management system 105 can alert the requesting user that the requested content item can be accessed as a shared content item. The user therefore can access the content item without completing the requested purchase. Content management system 105 can alert the requesting user by transmitting a message to the requesting user's client device 115ᵢ. The requesting user can then decide whether to continue to purchase the content item or cancel the purchase request.

Returning to the discussion of FIG. 1, in some embodiments, content management system 105 can be configured to notify a user that a content item is available as a shared content item only if another member of the group of linked user accounts has access to the content item and the other member has chosen to share the requested content item with the user. For example, a user account in the group of linked user accounts that has access to a requested content item, may have selected to not share that content item with the other members of the group of linked user accounts. Thus, content management system 105 will not notify the user that a content item is assigned to another user account in the group of linked user accounts unless the content item is being shared with the user and can therefore be accessed by the user as a shared content item. Content management system 105 can proceed to execute the requesting user's purchase request for the content item as though the content item is not assigned to another member of the group of linked user accounts.

In some embodiments, content management system 105 can be configured to present an indication that a content item is a shared content item assigned to another user in the group of linked user accounts and can therefore be accessed by the members of the group of linked user accounts. Content management system 105 can replace a purchase icon presented along with an on-sale content item, with an icon indicating that the content item can be accessed without purchase. For example, the purchase icon can be replaced with an icon of a cloud indicating that the content item is accessible to be accessed from content management system 105 without purchase.

In some embodiments, content management system 105 can present a user with a list of shared content items that are assigned to the other members of the group of linked user accounts, and are thus accessible to the user. For example, content management system 105 can provide a content item interface that lists the shared content items assigned to other user accounts in the group of linked user accounts. In some embodiments, content management system 105 can exclude content items from the list if the owning user has selected to not share the content item.

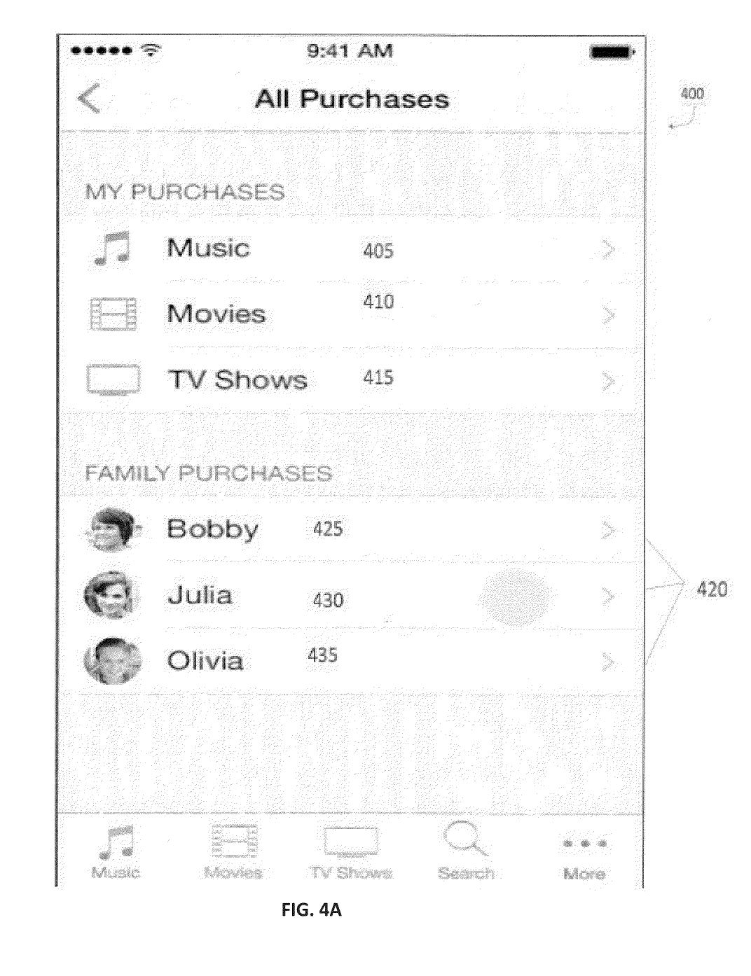

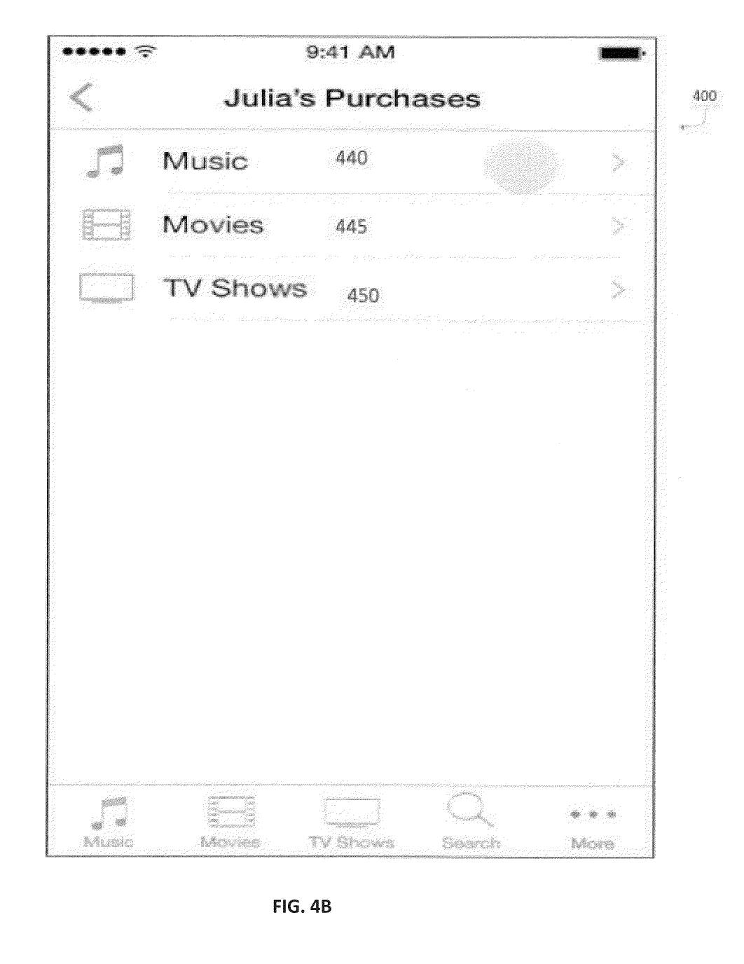

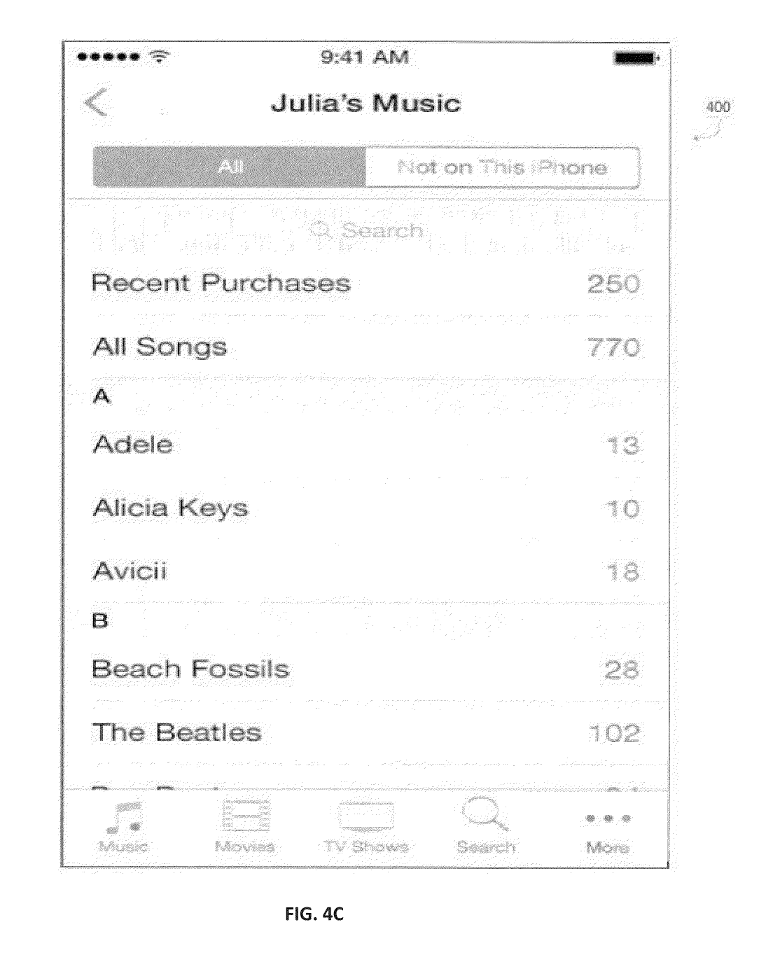

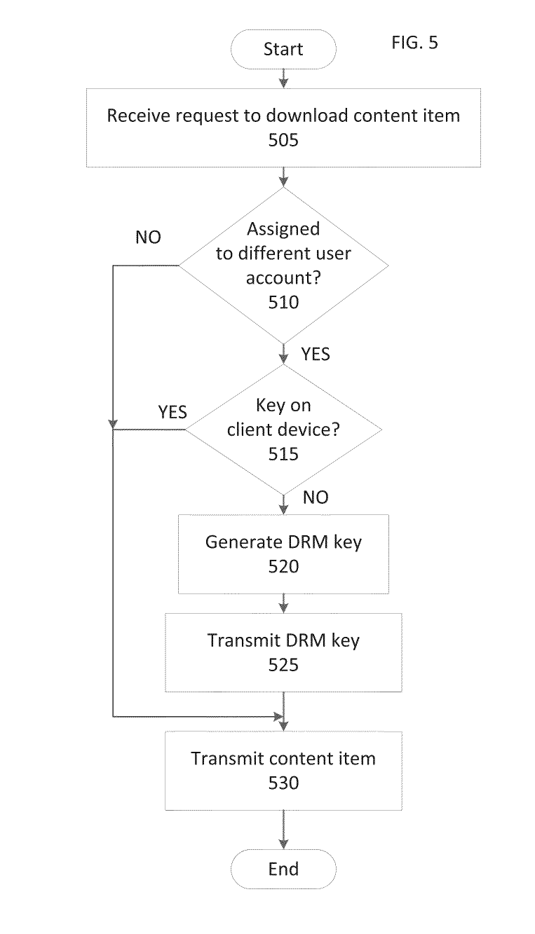

FIGS. 4A-4C illustrate exemplary screen shots of a content item interface 400. As shown in FIG. 4A, content item interface 400 can present to a user the content items assigned to the user's account. For example, the content item interface can allow the user to select to view the content items assigned to their user account based on the content item type. As shown content item interface 400 can include selectable portion 405 that enables a user to select to view music items assigned to their user account, selectable portion 410 that enable the user to select to view movies assigned to their user account and selectable portion 415 that enables the user to select to view TV shows assigned to their user accounts. A user can select one of selectable portions 405, 410 or 415 to bring up a listing of the content items of the specified type that are assigned to the user's account.

Further, content item interface 400 can enable the user to view content items assigned to other member of the group of linked user account that are accessible to the user. Content item interface 400 can include group member section 420 that lists the other members of the group of linked user accounts. As shown group member section 420 includes three selectable portions 425, 430 and 435, each representing a different member of the group of linked user accounts. To view the content items assigned to a specified member, the user can select the corresponding selectable portion 425, 430 or 435. For example, to view content items assigned to Julia, the user can select selectable portion 430.

FIG. 4B shows a second view of content item interface 400 resulting from a user selecting selectable portion 430 to view the content items assigned to Julia. As shown, content item interface 400 includes three selectable portions 440, 445, 450, that enable the user to select to view specified types of content items assigned to Julia. For example, to view music assigned to Julia's user account, a user can select selectable portion 440. Likewise, to view movies assigned to Julia's user account, a user can select selectable portion 445.

FIG. 4C shows a third view of content item interface 400 resulting from a user selecting selectable portion 440 to view the content items assigned to Julia's user account. As shown, the content items assigned to Julia's user account are listed. A user can select one of the content item to access the content item.

Returning to the discussion of FIG. 1, in some embodiments, content management system 105 can be configured to allow a user to download shared content items that are assigned to another member of the group of linked user accounts. Downloading a shared content item to the user's client device 115ᵢ can enable the user to access the content item without communicating with content management system 105. This can allow the user to access the content item while client device 115ᵢ is not in network communication with content management system 105.

To facilitate performance of a downloaded shared content item, content management system 105 can be configured to provide a Digital Rights Management (DRM) key along with the downloaded shared content item. The DRM key can enable the user's client device 115ᵢ to decrypt and operate the shared content item. For example, the shared content item can be configure to only allow performance of the content item if an authorized DRM key is available on client device 115ᵢ.

In some embodiments, the DRM key provided along with the shared content item can represent the group relationship between the downloading user account that downloaded the shared content item and the content owner's user account to which the shared content item is assigned. If either user account, the downloading user account or the content owner's user account, leave the group of linked user accounts, content management system 105 can invalidate the DRM key representing the group relationship between the two user accounts, thereby preventing the content item to be performed on the downloading user's client device 115ᵢ.

Using DRM keys that represent the group relationship between two user accounts can allow the relationship between the two user accounts to be severed while maintaining the relationship between other user accounts. For example, if a downloading user account downloads two shared content items that are each assigned to a different content owner's user account, one of the content owners can leave the group of linked user accounts without affecting the downloading user account's ability to access the content item assigned to the other content owner that remains a member of the group of linked user accounts. For example, upon a determination that a user account has left the group of linked user accounts, content management system 105 can be configured to invalidate any DRM keys representing the group relationship between a user account that is a member of the group of linked user accounts and the user account that left the group of linked user accounts. This can prevent the remaining members of the group of linked user accounts from accessing shared content items downloaded to their client devices 115 that were assigned to the user account that left the group of linked user account. DRM keys representing the group relationship between user accounts that remain members of the group of linked user accounts are not affected, thereby allowing the members of the group of linked user accounts to continue to access shared content items they downloaded that are assigned to a user account that remains a member of the group of linked user accounts.

To accomplish this, content management system 105 can include key module 130 that is configured to generate DRM keys that are transmitted to client devices 115 along with downloaded shared content items.

FIG. 5 illustrates an exemplary method embodiment of providing a DRM key along with a shared content item. The method is described in view of the system described in FIG. 1. As shown, the method begins at block 505 where the content management system 105 receives a request to download a content item. The request can be received from a client device 115ᵢ authorized on the user account of content management system 105.

At block 510, content management system 105 can determine whether the requested content item is assigned to a different user account in the group of linked user accounts. For example, content management system 105 can search user account database 150 to determine whether the requested content item is assigned to a user account in the group of linked user accounts different than the requesting user account.

If at block 510, the content management system 105 determines that the content item is not assigned to a different user account in the group of linked user accounts, i.e. it is assigned to the requesting user account, the method continues to block 530 where the requested content item is transmitted to the requesting client device 115ᵢ. The requested content item can be transmitted in an unrestricted format that does not require a DRM key because it is being downloaded by the user account that owns the content item. Alternatively, the content item can be transmitted with a DRM key that does not indicate a group relationship, but rather indicates that the requesting client device 115ᵢ is authorized to perform the content item.

If at block 510, content management system 105 determines that the content item is assigned to a user account in the group of linked user accounts that is different than the requesting user account, the method continues to block 515, where content management system 105 determines whether the requesting client device 115ᵢ already has a DRM key indicating the group relationship between the requesting user account and the user account to which the content item is assigned. For example, the requesting user account may have already downloaded a content item that was assigned to the other user account, to the requesting client device 115ᵢ.

If at block 510, content management system 105 determines that the requesting client device 115ᵢ does already have the DRM key, the method continues to block 530 where the requested content item is transmitted to the requesting client device 115ᵢ. The requesting client device 115, can then use the existing DRM key to perform the received content item.

Alternatively, if at block 515 content management system 105 determines that the requesting client device 115ᵢ does not already have the appropriate DRM key, the method continues to block 520 where key module 530 can generate the DRM key that represents the group relationship between the downloading user account and the content owner's user account to which the content item is assigned.

At block 525, content management system 105 can transmit the generated DRM key to the requesting client device 115ᵢ and at block 530, content management system 105 can transmit the requested content item to client device 115ᵢ. Client device 115 can use the generated DRM key to perform the requested content item.

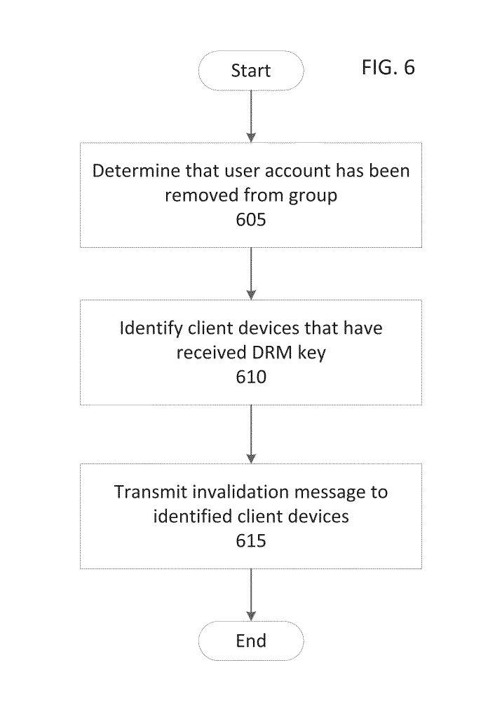

Returning to the discussion of FIG. 1, content management system 105 can be configured to determine if a user account has been removed from a group of linked user accounts, and then update the appropriate client devices 115 to invalidate DRM keys that represent a group relationship with the removed user account. FIG. 6 illustrates an exemplary method embodiment of invalidating DRM keys. The method is described in view of the system described in FIG. 1.

As shown, the method begins at block 605 where content management system 105 determines that a user account has been removed from a group of linked user accounts. For example, linking module 125 can be configured to receive and execute a request to remove a user account from a group of liked user accounts.

At block 610, content management system 105 can identify the client devices 115 that have received a DRM key that represents a group relationship with the user account that is being removed from the group of linked user accounts. For example, an index can be maintained on the DRM keys transmitted to client devices 115 and content management system 105 can search the index to identify the client devices 115 that received a DRM key that represents a group relationship with the removed user account.

At block 615, content management system 105 can transmit a invalidation message to the identified client devices 115 that informs the client devices 115 that the DRM key representing a group relationship with the removed user account should be invalidated. This can render the DRM keys unusable to enable performance of content items downloaded to the client devices 115 that are assigned to the removed user account.

Returning to the discussion of FIG. 1, in some embodiments, client devices 115 can be configured to determine whether a content item is a shared content item and flag content items determined to be shared content items. To accomplish this, client devices 115 can be configured to compare a content owner identifier tagged to a downloaded content item to a downloading account identifier that identifies the user account authorized on the downloading client device 115ᵢ. The content owner identifier can identify the content owner's user account to which the content item is assigned. For example, content management system 105 can be configured to tag the content item with the content owner identifier prior to transmitting the content item to the downloading client device 115ᵢ.

If the two identifiers match, the downloading user is the same as the content owner and the content item is therefore not a shared content item. Alternatively, if the two identifiers do not match, the downloading user and the content owner are not the same and it can be determined that the content item is a shared content item. The downloading client device 115ᵢ can then tag or flag the downloaded content item as a shared content item.

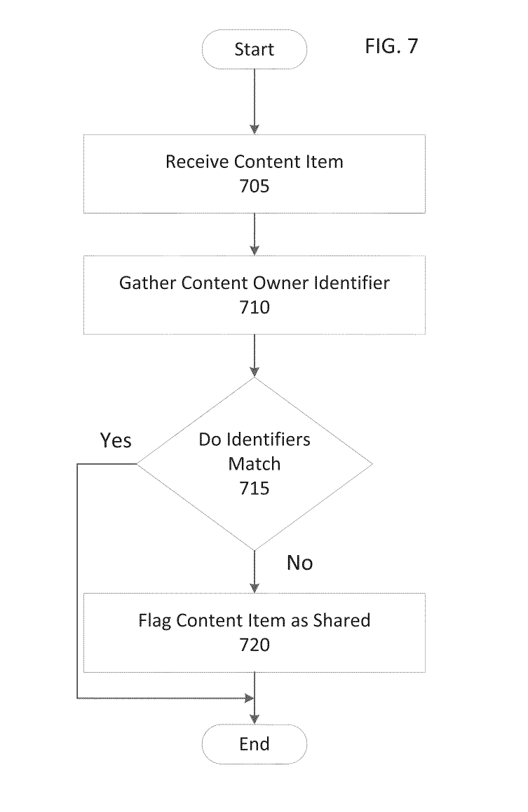

FIG. 7 illustrates an exemplary method embodiment of determining if a downloaded content item is a shared content item. The method is described in view of the system described in FIG. 1. As shown, the method begins at block 705 where a client device 115ᵢ receives a content item from the content management system.

At block 710, the client device 115, gathers the content owner identifier from the content item. The content owner identifier can identify the content owner's user account to which the content item is assigned. The content item can be tagged to the content items and the client device 115ᵢ can gather the content owner identifier from the content item.

At block 715, the client device 115ᵢ can determine whether the content owner identifier matches a downloading account identifier. The downloading account identifier can identify the user account authorized on client device 115ᵢ when the content item was downloaded from content management system 105.

If at block 715, client device 115ᵢ determines that the content owner identifier does not match the downloading account identifier, indicating that the content item is a shared content item, the method continues to block 720 where the client device 115ᵢ can flag the content item as a shared content item that is not assigned to the downloading user account. Alternatively, if at block 715 the client device 115ᵢ determines that the content owner identifier does match the downloading account identifier, indicating that the content item is assigned to the downloading user and thus is not a shared content item, the client device 115ᵢ does not flag the content item and the method ends.

Client device 115ᵢ can identify the shared content items downloaded to client device 115ᵢ by searching for the flagged content items. This can be useful if the downloading user account leaves the group of linked user accounts. Content management system 105 can notify the client devices 115 authorized on a user account that left the group of linked user accounts that the user account has left the group. In response, the notified client devices 115 can identify the content items flagged as shared content items and disable and/or remove them.

Disabling a content item can include any actions which result in the content item being unavailable and/or inaccessible to a user of the client device 115ᵢ while the client device 115ᵢ is authorized on the downloading user account (e.g., the user is logged into the downloading user account). For example, upon disabling a content item, the content item may no longer be presented in the user's media library and available to be accessed, even if the content item remains in memory on the client device 115ᵢ.

In some embodiments, if a user authorizes the client device 115ᵢ on the content owner's user account (e.g., the user account to which the disabled content item is assigned), the disabled content item may again be made available from local memory (e.g., the content item can be re-enabled). For example, the disabled content item can be presented in the media library and be available for access.

Disabling a content item can therefore cause the content item to be unavailable to user accounts that are not authorized to access the content item (e.g., user accounts to which the content item is not assigned and/or user accounts not included in a group of linked user accounts to which the content item is assigned). Likewise, disabling a content item can allow the content item to remain in memory and be available if the client device 115ᵢ is authorized on a user account that is authorized to access the content item. For example, if the user account again joins the group of linked user accounts or the user logs into a user account to which a disabled content item is assigned.

FIG. 8A illustrates a conventional system bus computing system architecture 700 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates a computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output 865, such as a display, and can read and write information to storage device 870, which can include magnetic media, and solid state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that exemplary systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, from a content management system, by a client device, a first content item, wherein:
the client device is authorized on a first user account of a group of linked user accounts,
the first content item is assigned to a second user account from the group of linked user accounts, and
the first content item is tagged with a first account identifier identifying the second user account;
determining, by the client device, that the first account identifier is different than a second account identifier identifying the first user account, yielding a determination that the first content item is not assigned to the first user account; and
based on the determination that the first content item is not assigned to the first user account, identifying, by the client device, the first content item as a shared content item.

2. The method of claim 1, further comprising:
receiving a second content item, wherein the second content item is assigned to a third user account from the group of linked user accounts, and the second content item is tagged with a third account identifier identifying the third user account;
determining that the third account identifier matches the second account identifier, yielding a determination that the second content item is assigned to the first user account.

3. The method of claim 1, further comprising:
receiving a first message indicating that the first user account is no longer a member of the group of linked user accounts; and
disabling, by the client device, the first content item that is a shared content item, wherein, upon being disabled, the first content item cannot be accessed by the client device while the client device is authorized on the first user account.

4. The method of claim 3, further comprising:
identifying a set of content items that are shared content items, the first content item being included in the set of content items.

5. The method of claim 3, wherein disabling the first content item comprises removing the content item from the client device.

6. The method of claim 3, further comprising:
authorizing the client device on the second user account; and
re-enabling the first content item.

7. The method of claim 3, further comprising:
receiving a second message indicating that the first user account is a member of the group of linked user accounts; and
re-enabling the first content item.

8. A client device comprising:
a computer processor; and
a memory containing instructions that, when executed, cause the computer processor to:
receive, from a content management system, a first content item, wherein:
the client device is authorized on a first user account of a group of linked user accounts,
the first content item is assigned to a second user account from the group of linked user accounts, and
the first content item is tagged with a first account identifier identifying the second user account;
determine that the first account identifier is different than a second account identifier identifying the first user account, yielding a determination that the first content item is not assigned to the first user account; and
based on the determination that the first content item is not assigned to the first user account, identify the first content item as a shared content item.

9. The client device of claim 8, wherein the instructions further cause the computer processor to:
receive a second content item, wherein the second content item is assigned to a third user account from the group of lined user accounts, and the second content item is tagged with a third account identifier identifying the third user account;
determine that the third account identifier matches the second account identifier, yielding a determination that the second content item is assigned to the first user account.

10. The client device of claim 8, wherein the instructions further cause the computer processor to:
receive a first message indicating that the first user account is no longer a member of the group of linked user accounts; and
disable the first content item that is a shared content item, wherein, upon being disabled, the first content item cannot be accessed by the client device while the client device is authorized on the first user account.

11. The client device of claim 10, wherein the instructions further cause the computer processor to:
identify a set of content items that are shared content items, the first content item being included in the set of content items.

12. The client device of claim 10, wherein disabling the first content item comprises removing the content item from the client device.

13. The client device of claim 10, wherein the instructions further cause the computer processor to:
authorize the client device on the second user account; and
re-enable the first content item.

14. The client device of claim 10, wherein the instructions further cause the computer processor to:
receive a second message indicating that the first user account is a member of the group of linked user accounts; and
re-enable the first content item.

15. A non-transitory computer-readable medium containing instructions that, when executed by a computer processor of a client device, cause the computer processor to:
receive, from a content management system, a first content item, wherein:
the client device is authorized on a first user account of a group of linked user accounts,
the first content item is assigned to a second user account from the group of linked user accounts, and
the first content item is tagged with a first account identifier identifying the second user account;
determine that the first account identifier is different than a second account identifier identifying the first user account, yielding a determination that the first content item is not assigned to the first user account; and
based on the determination that the first content item is not assigned to the first user account, identify the first content item as a shared content item.

16. The non-transitory computer-readable medium of claim 15, wherein the instructions further cause the computer processor to:
receive a second content item, wherein the second content item is assigned to a third user account from the group of lined user accounts, and the second content item is tagged with a third account identifier identifying the third user account;
determine that the third account identifier matches the second account identifier, yielding a determination that the second content item is assigned to the first user account.

17. The non-transitory computer-readable medium of claim 15, wherein the instructions further cause the computer processor to:
receive a first message indicating that the first user account is no longer a member of the group of linked user accounts; and
disable the first content item that is a shared content item, wherein, upon being disabled, the first content item cannot be accessed by the client device while the client device is authorized on the first user account.

18. The non-transitory computer-readable medium of claim 17, wherein the instructions further cause the computer processor to:
identify a set of content items that are shared content items, the first content item being included in the set of content items.

19. The non-transitory computer-readable medium of claim 17, wherein disabling the first content item comprises removing the content item from the client device.

20. The non-transitory computer-readable medium of claim 17, wherein the instructions further cause the computer processor to:
authorize the client device on the second user account; and
re-enable the first content item.

21. The non-transitory computer-readable medium of claim 17, wherein the instructions further cause the computer processor to:
receive a second message indicating that the first user account is a member of the group of linked user accounts; and
re-enable the first content item.

22. A method comprising:
receiving, by a computer processor, a purchase request from a first user account that is a member of a group of linked user accounts, wherein the purchase request is to purchase a first content item;
determining, by the computer processor, that the first content item is assigned to a second user account that is also a member of the group of linked user accounts; and
notifying, by the computer processor, the first user account that the first content item is assigned to the second user account that is also a member of the group of linked user accounts.

23. A method comprising:
receiving, by a computer processor, from a first user account, a download request to download a first content item, wherein:
the first user account and a second user account are members of a group of linked user accounts,
the first content item is not assigned to the first user account, and
the first content item is assigned to the second user account;
generating, by the computer processor, a Digital Rights Management (DRM) key that represents a group relationship between the first user account and the second user account, wherein the DRM key enables performance of the first content item by the first user account; and
transmitting, by the computer processor, to a first client device authorized on the first user account, the first content item along with the DRM key.
